(19) United States
(12) Patent Application Publication
(10) Pub. No.: US 2008/0149599 A1
(43) Pub. Date: Jun. 26, 2008

(54) Method for manufacturing an electrokinetic infusion pump

(75) Inventors: Sebastian Bohm, Los Gatos, CA (US); Richard Wiard, San Jose, CA (US)

Correspondence Address: NUTTER MCCLENNEN & FISH LLP, WORLD TRADE CENTER WEST, 155 SEAPORT BOULEVARD, BOSTON, MA, 02210-2604, US

(73) Assignee: LifeScan, Inc., Milpitas, CA (US)

(21) Appl. No.: 11/614,521

(22) Filed: Dec. 21, 2006

(51) Int. Cl. B32B 38/10; B32B 38/06; B23P 15/00

(52) U.S. Cl. 216/94; 156/60; 156/250; 156/219; 29/888.02

(57) ABSTRACT

A method for producing a porous flow-through element for use in an electrokinetic infusion pump is provided and generally includes providing a porous membrane that is entirely porous along both its length and width, treating the membrane by selectively inactivating portions of the membrane in a desired pattern to define active regions that allow fluid flow therethrough and inactive regions that do not, and laminating the treated membrane. Various techniques can be used to treat the membrane including, for example, applying a heated embossing die to the membrane, contacting selected portions of the membrane with laser energy, applying a pore-penetrating chemical to the membrane, and cutting and removing selected portions of the membrane. The resulting treated membrane can be laminated between opposed films having one or more perforations therethrough with each perforation being aligned with an active region to define a fluid flow pathway therebetween.

### FIELD OF THE INVENTION

The present invention relates to methods of manufacturing an electrokinetic infusion pump and more particularly to methods for producing a porous flow-through element for use in an electrokinetic infusion pump.

### BACKGROUND OF THE INVENTION

Electrokinetic pumps provide for liquid displacement by applying an electric potential across a porous dielectric media that is filled with an ion-containing electrokinetic solution. Properties of the porous dielectric media and ion-containing solution (e.g., permittivity of the ion-containing solution and zeta potential of the solid-liquid interface between the porous dielectric media and the ion-containing solution) are predetermined such that an electrical double-layer is formed at the solid-liquid interface. Thereafter, ions of the electrokinetic solution within the electrical double-layer migrate in response to the electric potential, transporting the bulk electrokinetic solution with them via viscous interaction. The resulting electrokinetic flow (also known as electroosmotic flow) of the bulk electrokinetic solution is employed to displace (i.e., “pump”) a liquid.

The porous flow-through element, which generally includes the porous dielectric media or electrokinetic material laminated in a polymer, is a key component of the electrokinetic pump. The porous flow-through element is bonded within the pump and separates the pump body into two chambers. If the electrokinetic material is charged, pressure and fluid flow can be generated by applying a voltage at the two sides of the porous flow-through element. It is critical to the operation of the electrokinetic pump that the electrokinetic solution flow through the porous flow-through element without leaking around the exterior of the porous flow-through element or between the electrokinetic material and the laminate. One known approach to making the porous flow-through element is by laminating electrokinetic material between two pieces of plastic using a temperature sensitive adhesive, however, there are various drawbacks to this technique. For example, the adhesive often flows into the inlet and outlet ports of the porous flow-through element and must be manually removed. In addition, several layers of adhesive must be used, increasing the complexity and cost of the process. The quality of the adhesive bond also depends on time, temperature, pressure, and geometry, making the lamination process difficult to control.

Accordingly, there is a need for improved methods for preparing a porous flow-through element for use in an electrokinetic infusion pump.

### SUMMARY OF THE INVENTION

In one aspect the invention provides a method for manufacturing electrokinetic infusion pumps. In particular, one exemplary embodiment provides a method for producing a porous flow-through element for use in an electrokinetic pump. The method includes providing a porous membrane, treating the membrane, and laminating the treated membrane. The porous membrane can be in sheet form and entirely porous along both its length and width. A variety of materials can be used to form the porous membrane including, for example, polyvinylidene fluoride (PVDF), nylons, polytetrafluoroethylene (PTFE), cellulose, nitro-cellulose, porous alumina, papers, porous ceramics, and polyolefines such as polyethylene.

In one aspect, the membrane can be treated by selectively inactivating portions of the membrane in a desired pattern to define active regions that allow fluid flow therethrough and inactive regions that do not permit fluid flow. Various techniques are available for treating the membrane. For example, in one exemplary embodiment, treating the membrane can include applying a heated embossing die to the membrane to locally soften and/or melt and thereby inactivate (i.e., close and/or collapse the pores) selected portions of the membrane. Inactivated membrane portions will not allow fluid flow. Thus, fluid flow can be confined to the active regions of the membrane. Other embodiments can include contacting selected portions of the membrane with laser energy, applying a pore-penetrating and clogging chemical, such as an ink, to portions of the membrane, and cutting and removing selected portions of the membrane using, for example, a rotating die cutter.

Once selected portions of the membrane are inactivated, the resulting treated membrane can be laminated to create a fluid flow path. The treated membrane can be laminated between first and second sheets of lamination film that include one or more perforations therethrough. Each perforation can be aligned with an active region of the treated membrane such that the resulting laminated membrane has a perforation at a top portion and a bottom portion of each active region to define a fluid flow pathway therebetween. Treating the porous membrane to inactivate select portions and laminating the treated membrane can be performed as discrete steps or as part of a continuous process. In an exemplary embodiment, an adhesive material such as a temperature sensitive adhesive, pressure sensitive adhesive, or UV curable adhesive can be applied between the treated membrane and the opposed polymer sheets prior to lamination to encourage adhesion between the porous membrane and the laminate.

The method can also include cutting the laminated membrane to yield a plurality of porous flow-through elements having a thickness in the range of about 10-1000 micrometers. Each porous flow-through element can include a top lamination film that is fluid impervious with at least one perforation that is positioned adjacent an active region of the membrane and a bottom lamination film that is fluid impervious with at least one perforation that is positioned adjacent an active region of the membrane. In an exemplary embodiment, the perforations of the top and bottom lamination films can be positioned at opposite ends of the porous flow-through element such that fluid is able to flow from one perforation longitudinally through the active region of the membrane and through the perforation in the opposite film. In another exemplary embodiment, the perforations of the top and bottom lamination films can be aligned such that fluid flows from one perforation through the active region of the membrane in a direction transverse to a longitudinal axis of the porous membrane and through the perforation in the opposite film. Once the laminated membrane is cut into a plurality of porous flow-through elements, an electrokinetic infusion pump can be assembled by inserting a flow-through element into a chamber of the pump.

### BRIEF DESCRIPTION OF THE DRAWINGS

The invention will be more fully understood from the following detailed description taken in conjunction with the accompanying drawings, in which:

FIG. 1 is a flow diagram of one embodiment of a method for producing a porous flow-through element;

FIG. 2 is a side view of one embodiment of a heated embossing die being applied to a porous membrane;

FIG. 3 is a top view of one embodiment of a treated membrane;

FIG. 4 is a cross-sectional view of the membrane shown in FIG. 3 at lines 4-4;

FIG. 5 is a side view of one embodiment of a die cutter being applied to a porous membrane;

FIG. 6 is a side view of one embodiment of laminating a treated membrane;

FIG. 7A is a perspective view of one embodiment of a porous flow-through element produced in accordance with the invention;

FIG. 7B is a cross-sectional view of the porous flow-through element shown in FIG. 7A; and

FIG. 8 is an exploded schematic illustration of an electrokinetic infusion pump system with a porous flow-through element disposed therein.

### DETAILED DESCRIPTION OF THE INVENTION

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present invention.

The features disclosed herein are applicable to a variety of electrokinetic infusion pump systems. For example, the methods disclosed herein can be used in the manufacture of electrokinetic infusion pumps and electrokinetic infusion pump systems of the type disclosed in U.S. patent application Ser. No. 11/532,587, filed Sep. 18, 2006, entitled “Electrokinetic Infusion Pump System,” which is incorporated herein in its entirety. Such electrokinetic infusion pumps may include additional features such as error, malfunction, and position sensor detection systems including those disclosed in U.S. patent application Ser. No. 11/532,691, filed Sep. 18, 2006, entitled “Malfunction Detection With Derivative Calculation,” and U.S. patent application Ser. No. 11/614,211, filed Dec. 21, 2006, entitled “Malfunction Detection In Infusion Pumps,” both of which are likewise incorporated herein in their entirety.

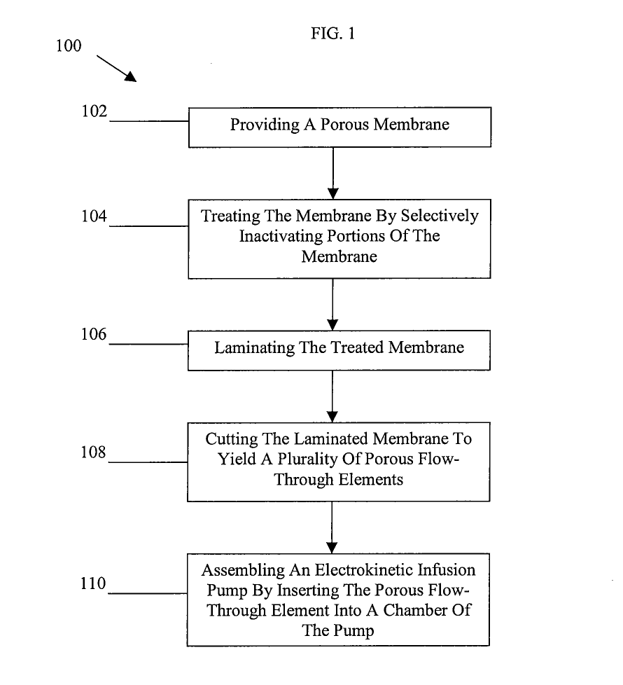

The present invention provides methods for producing a porous flow-through element for use in an electrokinetic infusion pump. As shown in FIG. 1, the method 100 can generally include providing a porous membrane 102 that is entirely porous along both its length and width, treating the membrane 104 by selectively inactivating portions of the membrane, and laminating the treated membrane 106. Subsequent steps, further described below, can include the step 108 of cutting the laminated membrane to yield a plurality of porous flow-through elements and the step 110 of assembling an electrokinetic infusion pump by inserting the porous flow-through element into a chamber of the pump.

Various porous materials can be used in conjunction with the method, and the porous material can be selected for desired surface chemistry, surface charge, pore size, pore topology, and formation factor. The pore geometry of the material can be chosen with the design of the flow system in mind, in particular, whether fluid flow will be normal to the plane of the material or in the plane of the material along its length. Porous materials suitable for use with the method include, for example, polyvinylidene fluoride (PVDF), nylons, polytetrafluoroethylene (PTFE), cellulose, nitro-cellulose, porous alumina, papers, porous ceramics, and polyolefins such as polyethylene. The porous material is preferably in the form of a membrane sheet or film having a thickness appropriate for lamination, for example, approximately 50-250 microns.

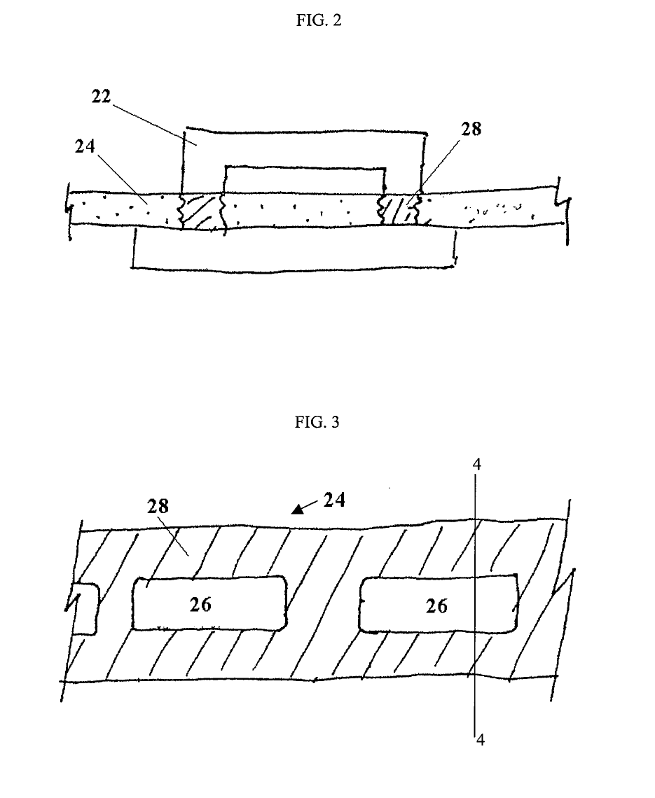

As shown in FIG. 1, once the appropriate porous membrane is selected, the membrane can be treated by selectively inactivating portions of the membrane 104 in a desired pattern to define active regions that allow fluid flow therethrough and inactive regions that do not. A variety of techniques are available for treating the membrane 104. For example, in one exemplary embodiment, treating the membrane can include applying a heated embossing die to the membrane to selectively inactivate portions of the membrane in a desired pattern. As shown in FIG. 2, in this embodiment, a heated embossing die 22 is applied to or pressed onto the porous membrane 24. The combination of heat and pressure from the embossing die 22 can be effective to locally melt select portions 28 of the porous membrane 24 in a pattern according to the size, shape, and configuration of the embossing die 22.

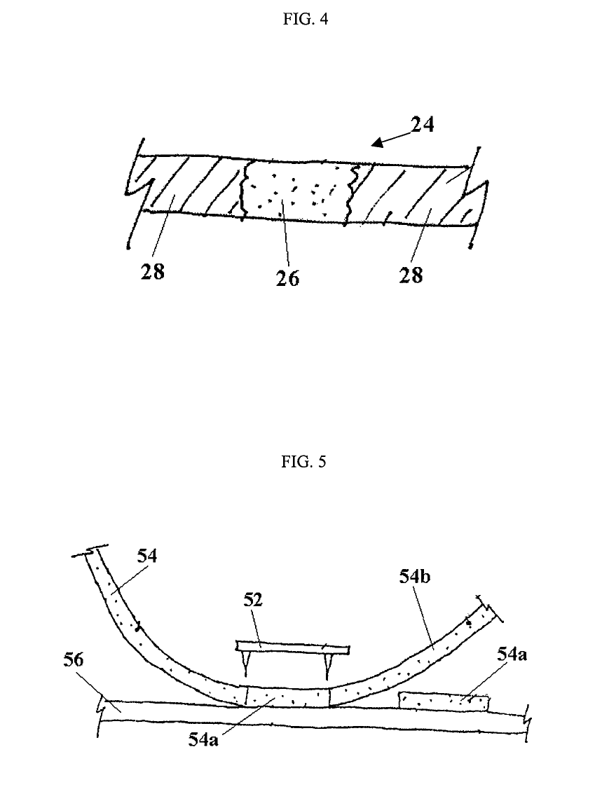

FIG. 3 shows a top view of the treated membrane 24, and FIG. 4 provides a cross-sectional view of the treated membrane 24. Both FIGS. 3 and 4 illustrate that the resulting membrane 24 includes an active membrane portion 26 and an inactive membrane portion 28. The pores in the inactivated portion 28 are generally sealed closed as a result of the heat and pressure applied by the embossing die 22, while the pores in the active region 26 remain open. Thus, fluid flow can be constrained to the active region 26 of the treated membrane 24.

The operating parameters of the embossing process, such as temperature of the heated embossing die 22, pressure applied by the embossing die 22, and duration of the embossing process, can vary with the material and thickness of the porous membrane 24. For example, in an exemplary embodiment, the porous membrane 24 can be made of polyvinylidene fluoride (PVDF). As PVDF has a melting temperature of about 150° C., the embossing die 22 should have a temperature of at least 150° C. and be applied to the membrane at about 5-50 bar for approximately 0.1-10 seconds to effectively inactivate select portions of the PVDF membrane 24. One skilled in the art will appreciate that a variety of configurations are available for the embossing die 22. For example, the embossing die 22 can be in the form of a traditional stationary die press or it can be in the form of a rotary die wheel.

In another exemplary embodiment, treating the membrane can include contacting selected portions of the porous membrane with laser energy to selectively inactivate portions of the membrane in a desired pattern. Similar to the heat and pressure applied by the embossing die 22, the laser energy can be effective to locally melt select portions of the porous membrane to close the pores in these portions. Process parameters, such as excitation power, pulse length, and/or number of passes can be varied to create a porous membrane having active and inactive regions in a desired pattern. An advantage to laser energy is that it can separate the delicate active membrane from the inactive membrane without mechanically deforming the desired geometry of the active membrane.

Treating the membrane can also include applying a pore-penetrating chemical to the membrane to selectively inactivate portions of the membrane in a desired pattern. A variety of pore-penetrating chemicals can be used to selectively inactivate the membrane. For example, in one exemplary embodiment, the pore-penetrating chemical can be a screen-printable dielectric ink such as Nr 118-12, which can be obtained from Creative Materials Incorporated, 141 Middlesex Road, Tyngsboro, Mass. 01879. Here, the ink can be applied to the portions of the membrane to be inactivated and can be effective to seal or close the pores in these portions. Similar to the laser energy, the ink can separate the delicate active membrane from the inactive membrane without mechanically deforming the desired geometry of the active membrane.

In yet another embodiment, treating the membrane can include cutting and removing selected portions of the membrane to create a desired pattern. As shown in FIG. 5, the porous membrane 54 is positioned on a bottom film 56, and a die cutter 52 is used to cut out select portions 54a of the membrane 54. A variety of techniques can be used to cut the membrane 54 including, for example, a conventional stationary die cutter or a rotating die cutter. The cut-out portions 54a can remain on the bottom film 56 to form active regions, and the waste portion 54b can be lifted from the bottom film 56. This can be accomplished by applying an adhesive layer to the bottom film 56 and applying pressure to the cut-out sections during the cutting operation. In one embodiment, the adhesive can be a temperature sensitive adhesive that is locally activated by the die cutter 52. If a heat sensitive adhesive is used, the temperature required to activate the adhesive should not exceed the melting point of the porous membrane 54, as the cut-out portion 54a of the membrane 54 should remain active. In an exemplary embodiment, the bottom film 56 can have one or more perforations therethrough that are aligned with the cut-out portions 54a of the membrane 54 to form inlet/outlet ports to the active regions of the membrane. In another embodiment, perforations can be cut in the bottom film 56 after the cut-out portions 54a of the membrane 54 are applied thereto. As is explained below in detail, once the cut-out or active regions 54a are adhered to the bottom film 56, a top film can be applied to form the porous flow-through element.

Referring back to FIG. 1, once selected portions of the membrane are inactivated 104, the resulting treated membrane can be laminated 106 to create a fluid flow pathway. To form a fluid flow pathway through the active region of the membrane, the top and bottom surfaces of the treated membrane can be covered or sealed. A variety of polymers can be used to laminate the treated membrane including, for example, polyethylene, polypropylene, polystyrene, polyethylene vinyl acetate, polyethylene ethyl acetate, ionomers, polyamides, polyesters, and polyurethanes. In an exemplary embodiment, an adhesive material such as a temperature sensitive adhesive, pressure sensitive adhesive, or UV curable adhesive can be applied between the treated membrane and the opposed polymer sheets prior to lamination to encourage adhesion between the porous membrane and the laminate. As indicated above, if a temperature sensitive adhesive is used, it is important that the lamination temperature be sufficiently low to leave the pores of the active region of the membrane intact.

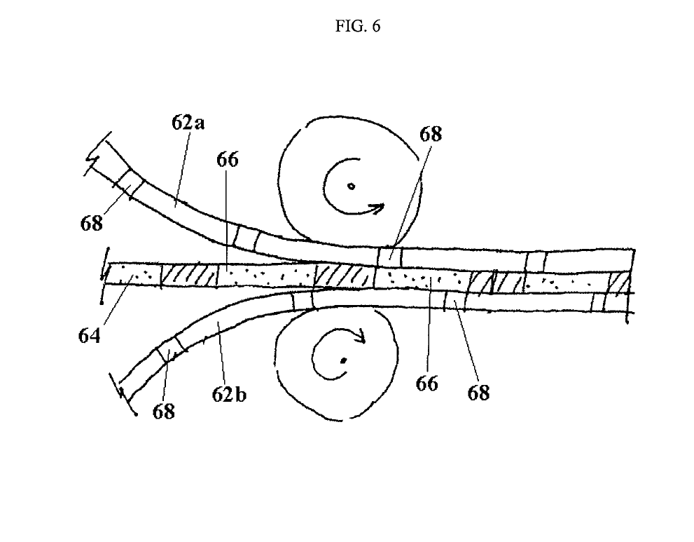

As shown in FIG. 6, the treated membrane 64 is laminated between first and second sheets of lamination film 62a, 62b that include one or more perforations 68 therethrough. Each perforation 68 can be aligned with an active region 66 of the treated membrane 64 such that the resulting laminated membrane has a perforation 68 at a top portion and a bottom portion of each active region 66 to define a fluid flow pathway therebetween. In another embodiment (not shown), the first and second lamination films do not include perforations. In such a case, the treated membrane can be partially laminated such that a fluid flow pathway exists around the perimeter of the porous membrane. Alternatively, perforations can be cut in the lamination films following the lamination process. Although the method is shown and described as laminating the treated membrane between first and second sheets of lamination film, in another exemplary embodiment, such as the die cutter embodiment described above, the porous membrane can be provided “pre-mounted” on an impermeable bottom film. In such a case, it is only necessary to apply a top lamination film to the treated membrane.

A person skilled in the art will appreciate that the steps of treating the porous membrane to inactivate select portions 104 and laminating the treated membrane 106 can be performed as discrete steps or as a continuous process. This concept is not limited to the inactivation and lamination steps, as the entire method for preparing the porous flow-through element can be performed as a continuous process or as a series of discrete steps.

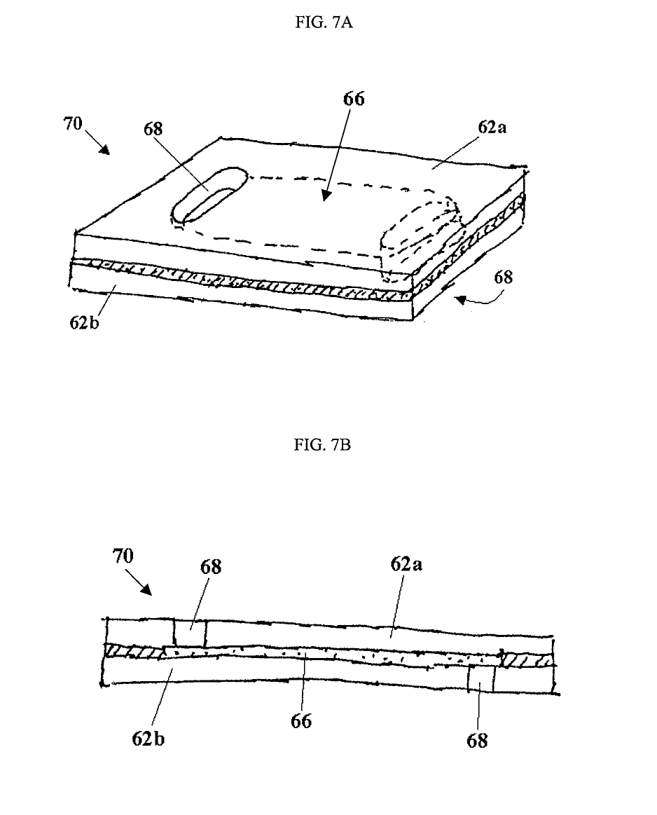

Returning to FIG. 1, the method 100 can also include cutting the laminated membrane to yield a plurality of porous flow-through elements 108. A variety of machining techniques known in the art, such as using a high speed flying wheel cutter, can be implemented to cut the laminated membrane into a plurality of porous flow-through elements having a thickness in the range of about 10 micrometers to 2 millimeters. In an exemplary embodiment, shown in FIGS. 7A and 7B, each porous flow-through element 70 includes a top lamination film 62a that is fluid impervious with at least one perforation 68 that is positioned adjacent an active region 66 of the membrane and a bottom lamination film 62b that is fluid impervious with at least one perforation 68 that is positioned adjacent an active region 66 of the membrane. As shown, the perforations 68 of the top and bottom lamination films 62a, 62b are positioned at opposite ends of the porous flow-through element 70 such that fluid is able to flow from one perforation longitudinally through the active region of the membrane and through the perforation in the opposite film. In another exemplary embodiment, the perforations of the top and bottom lamination films can be aligned such that fluid flows from one perforation through the active region of the membrane in a direction transverse to a longitudinal axis of the porous membrane and through the perforation in the opposite film.

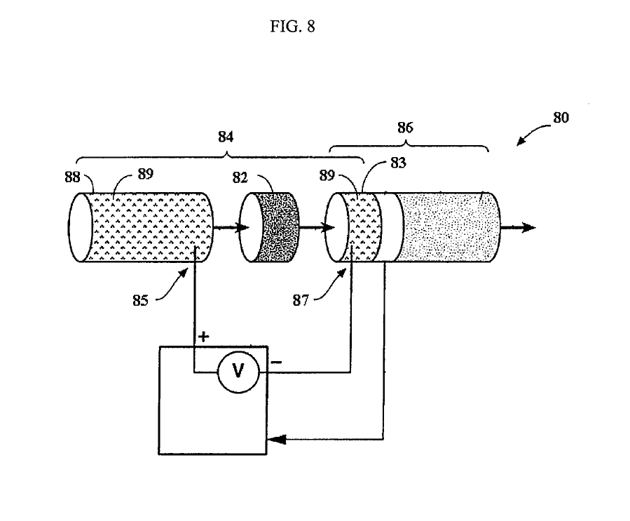

As indicated in FIG. 1, once the laminated membrane is cut into a plurality of porous flow-through elements 108, an electrokinetic infusion pump can be assembled by inserting a flow-through element into a chamber of the pump 110. FIG. 8 is a schematic illustration of an exemplary electrokinetic infusion pump system 80 with a porous flow-through element 82 disposed therein. As shown, the system 80 includes an electrokinetic engine 84 and an infusion module 86. The engine 84 can include an electrokinetic supply reservoir 88, a porous flow-through element 82, an electrokinetic solution receiving chamber 83, a first electrode 85, a second electrode 87, and an electrokinetic solution 89. During operation of the pump system 80, a voltage difference can be established across the porous flow-through element 82 by the application of an electrical potential between the first electrode 85 and the second electrode 87. This electrical potential results in an electrokinetic pumping of the solution 89 from the supply reservoir 88, through the porous flow-through element 82, and into the solution receiving chamber 83.

One skilled in the art will appreciate further features and advantages of the invention based on the above-described embodiments. Accordingly, the invention is not to be limited by what has been particularly shown and described, except as indicated by the appended claims. All publications and references cited herein are expressly incorporated herein by reference in their entirety.

What is claimed is:

1. A method for producing a porous flow-through element of an electrokinetic infusion pump, comprising:
providing a porous membrane that is entirely porous along both its length and width;
treating the membrane by selectively inactivating portions of the membrane in a desired pattern to define active regions that allow fluid flow therethrough and inactive regions that do not; and
laminating the treated membrane.

2. The method of claim 1, wherein the treated membrane is laminated between first and second sheets of lamination film, the first and second sheets each having one or more perforations therethrough, each of the perforations being aligned with an active region of the treated membrane such that the resulting laminated membrane has a perforation at a top portion and a bottom portion of each active region to define a fluid flow pathway therebetween.

3. The method of claim 1, further comprising cutting the laminated membrane to yield a plurality of porous flow-through elements each having a top lamination film that is fluid impervious with at least one perforation that is positioned adjacent an active region of the membrane and a bottom lamination film that is fluid impervious with at least one perforation that is positioned adjacent an active region of the membrane.

4. The method of claim 3, wherein the perforations of the top and bottom lamination films are positioned at opposite ends of the porous flow-through element such that fluid is able to flow from one perforation longitudinally through the active region of the membrane and through the perforation in the opposite film.

5. The method of claim 3, wherein the perforations of the top and bottom lamination films are aligned such that fluid flows from one perforation through the active region of the membrane in a direction transverse to a longitudinal axis of the porous membrane and through the perforation in the opposite film.

6. The method of claim 3, further comprising assembling an electrokinetic infusion pump by inserting the porous flow-through element into a chamber of the pump.

7. The method of claim 1, wherein treating the membrane comprises applying a heated embossing die to the membrane to selectively inactivate portions of the membrane in a desired pattern.

8. The method of claim 1, wherein treating the membrane comprises contacting selected portions of the porous membrane with laser energy to selectively inactivate portions of the membrane in a desired pattern.

9. The method of claim 1, wherein treating the membrane comprises applying a pore-penetrating chemical to the membrane to selectively inactivate portions of the membrane in a desired pattern.

10. The method of claim 9, wherein the pore-penetrating chemical is an ink.

11. The method of claim 1, wherein treating the membrane comprises cutting and removing selected portions of the membrane to create a desired pattern.

12. The method of claim 11, wherein cutting the membrane comprises applying a rotating die cutter to the membrane.

13. The method of claim 1, wherein treating the membrane and laminating the treated membrane is performed as a continuous process.

14. The method of claim 1, wherein an adhesive material selected from the group consisting of pressure sensitive adhesive, heat sensitive adhesive, and UV curable adhesive is applied between the porous membrane and the first and second sheets of lamination film prior to laminating.

15. The method of claim 1, wherein the porous membrane is in sheet form.

16. The method of claim 3, wherein the porous flow-through element has a thickness in the range of about 10 micrometers to 2 millimeters.

17. The method of claim 1, wherein the porous membrane is made from a material selected from the group consisting of polyvinylidene fluoride (PVDF), nylons, polytetrafluoroethylene (PTFE), cellulose, nitro-cellulose, porous alumina, papers, porous ceramics, and polyethylene.

18. A method for producing a porous flow-through element of an electrokinetic infusion pump, comprising:
providing a porous membrane that is entirely porous along both its length and width;
treating the membrane by selectively inactivating portions of the membrane in a desired pattern to define active regions that allow fluid flow therethrough and inactive regions that do not;
laminating the treated membrane;
cutting the laminated membrane to yield a plurality of porous flow-through elements; and
inserting the porous flow-through element into a chamber of an electrokinetic infusion pump.

19. The method of claim 18, wherein the treated membrane is laminated between first and second sheets of lamination film, the first and second sheets each having one or more perforations therethrough, each of the perforations being aligned with an active region of the treated membrane such that the resulting laminated membrane has a perforation at a top portion and a bottom portion of each active region to define a fluid flow pathway therebetween.

20. The method of claim 19, wherein each porous flow-through element has a top lamination film that is fluid impervious with at least one perforation that is positioned adjacent an active region of the membrane and a bottom lamination film that is fluid impervious with at least one perforation that is positioned adjacent an active region of the membrane.
